(19) United States
(12) Patent Application Publication
(10) Pub. No.: US 2016/0260435 A1
(43) Pub. Date: Sep. 8, 2016

(54) ASSIGNING VOICE CHARACTERISTICS TO A CONTACT INFORMATION RECORD OF A PERSON

(71) Applicant: SONY CORPORATION, Tokyo (JP)

(72) Inventors: Henrik Baard, Lund (SE); Peter Isberg, Lund (SE)

(73) Assignee: Sony Corporation, Tokyo (JP)

(21) Appl. No.: 14/431,611

(22) PCT Filed: Apr. 1, 2014
(86) PCT No.: PCT/IB2014/060349

§ 371 Date: Mar. 26, 2015

(51) Int. Cl. G10L 17/04; G10L 25/51; H04M 3/56; G10L 17/06

(52) U.S. Cl. CPC G10L 17/04; G10L 17/06; G10L 25/51; H04M 3/568

(57) ABSTRACT

The present invention relates to a method for assigning voice characteristics to a contact information record of a person in a user equipment. According to the method, a communication connection of the user equipment relating to contact information of the contact information record of the person is automatically detected and audio voice data received via the communication connection is automatically captured. Based on the captured audio voice data, voice characteristics are automatically determined and assigned to the contact information record of the person.

### TECHNICAL FIELD

The present invention relates to a method for assigning voice characteristics to a contact information record of a person in a user equipment, for example to a phone book entry in a user equipment. The present invention relates furthermore to a method for automatically identifying a person with a user equipment based on voice characteristics. The present invention relates furthermore to a user equipment, for example a mobile telephone, implementing the methods.

### BACKGROUND ART

User equipments, for example mobile phones, especially so called smart phones, tablet PCs or mobile computers, may provide a lot of media data comprising for example videos, images and audio data. The media data may be tagged with information relating to the content of the media data, for example a geographic position where an image has been taken, a time and date when a video has been taken or which persons are shown in a video or an image. This tagging information may be used for example in albums in the mobile phone and also when posting images and videos to online forums. The tagging information may be stored along with the media data as meta data. However, adding such meta data may be a boring task.

Therefore, it is an object of the present invention to support, simplify and automatize tagging of media data.

### SUMMARY

According to the present invention, this object is achieved by a method for assigning voice characteristics to a contact information record of a person in a user equipment as defined in claim 1, a user equipment as defined in claim 5, a method for automatically identifying a person with a user equipment as defined in claim 7 and a user equipment in defined in claim 13. The dependent claims define preferred and advantageous embodiments of the invention.

According to an aspect of the present invention, a method for assigning voice characteristics to a contact information record of a person in a user equipment is provided. Voice characteristics is also known as voice print and is just as a fingerprint an important biometric authentication. Therefore, a voice print may be used as a form of biometric for identification. Just like a fingerprint, a voiceprint is a physiological biometric unique information about a person's vocal track and behavior of the person's speaking pattern. According to the method, a communication connection of the user equipment is automatically detected with a processing device of the user equipment. The communication connection relates to a contact information of the contact information record of the person.

For example, the communication connection may comprise a telephone call and the telephone call has been set up using a telephone number which is registered in the contact information record of the person. The contact information record may be a part of a database of the user equipment, for example an electronic phone book. This data base does not necessarily have to be a part of the user equipment itself, but it may also be provided at a location outside the user equipment. For example, the data base may be provided by a cloud service or an online service, such as an online account, the user equipment having access to this database by a wireless or wired data connection. Additionally or as an alternative, the communication connection may comprise for example a video telephone call via an internet service like Skype, and the video telephone call may be set up using the contact information of the contact information record of the person. Furthermore, as an alternative or additionally, a video conference call may be set up using the contact information of the contact information record of the person.

Next, audio voice data received via the communication connection is automatically captured with the processing device. Based on the captured audio voice data, the voice characteristics are automatically determined with the processing device. The determined voice characteristics are automatically assigned to the contact information record of the person by the processing device. In other words, according to the above-described method, voice characteristics of a person are automatically captured during a communication with the person. The determined voice characteristics are assigned to the contact information record of the person, for example to a phone book entry of the user equipment. Thus, voice characteristics or voice prints of a plurality of people may automatically be gathered and stored in connection with contact information of the people. Based on the voice characteristics or voice prints, media data may be automatically tagged as will be described below in connection with another aspect of the present invention.

According to an embodiment, the processing device automatically detects a further communication connection relating to contact information of the contact information record of the same person, and automatically captures further audio voice data received via the further communication connection. Based on the further audio voice data, the processing device automatically determines a further voice characteristics and compares the voice characteristics and the further voice characteristics. Based on the comparison, the processing device automatically assigns the determined voice characteristics as confirmed voice characteristics to the contact information record of the person. Although the person is related to the contact information record, it cannot be guaranteed that the captured audio voice data belongs to the person. Instead, another person may use a communication device of the person and therefore audio voice data of the other person may be captured. For increasing reliability, according to the embodiment described above, a further communication connection relating to contact information of the contact information record of the same person is detected and based on corresponding audio voice data, further voice characteristics are determined and compared with the previously determined voice characteristics. In case the voice characteristics and the further voice characteristics are matching, it may be assumed that this voice characteristics are indeed belonging to the person relating to the contact information record. However, even more than two audio voice data samples may be captured on different communication connections relating to contact information of the contact information record of the same person to increase confidence in that the captured audio voice data really belongs to the person. In other words, the identification process for identifying the voice characteristics of a person uses not only one voice print, but uses two or more voice prints and checks if they are matching. If they are matching, the determined voice characteristics may be stored as confirmed voice characteristics for that person.

Alternatively or in addition, it may also be possible to assign probabilities to the voice characteristics or voice prints such that the more often a user talks to a contact, the more voice prints for this contact would be available and the higher would be the probability that the voice print of this contact is indeed correct (provided that the voice prints aquired during the individual calls more or less match). If media data is automatically tagged on the basis of a voice print, which will be described below in more detail, this approach could be used to use only voice prints for the tagging which have a predetermined minimum probability or higher so as to make sure that the media data is not tagged with voice prints that may be wrong or that are not very reliable.

According to a further embodiment, the contact information record is stored in a database which is accessible by the processing device. The voice characteristics are also stored in the database. The database may comprise for example an electronic phone book and may be stored for example on the user equipment or may be stored on a server accessible by the processing device. By storing the voice characteristics and especially the confirmed voice characteristics in connection with the contact information record, the person may be identified later on based on the voice characteristics as will be described in more detail below.

According to a further embodiment, determining the voice characteristics comprises analyzing physiological biometric properties based on the audio voice data. Additionally or as an alternative, the voice characteristics may comprise for example a spectrogram representing the sounds in the captured audio voice data.

According to another aspect of the present invention, a user equipment is provided. The user equipment comprises a transceiver for establishing a communication connection, an access device for providing access to a plurality of contact information records, and a processing device. Each contact information record comprises contact information and is assigned to a person. The processing device is configured to detect a communication connection of the transceiver, and to identify a contact information record of the plurality of contact information records whose contact information matches the detected communication connection. Furthermore, the processing device is configured to capture audio voice data received via the communication connection and to determine voice characteristics based on the captured audio voice data. The determined voice characteristics are assigned by the processing device to the identified contact information record. Thus, the user equipment is configured to perform the above-described method and comprises therefore the above-described advantages. The user equipment may comprise for example a desktop computer, a telephone, a notebook computer, a tablet computer, a mobile telephone, especially a so called smart phone, and a mobile media player.

According to another aspect of the present invention a method for automatically identifying a person by means of a user equipment is provided. According to the method, a plurality of contact information records are provided. Each contact information record is assigned to a person and comprises voice characteristics of the person. The voice characteristics of the person may have been determined with the method described above. With a processing device of the user equipment, media data comprising audio voice data of the person to be identified are received. Based on the received audio voice data the processing device automatically determines voice characteristics of the person to be identified. Furthermore, the processing device automatically determines at least one contact information record of the plurality of contact information records whose voice characteristics matches the voice characteristics of the person to be identified. The media data may comprise for example video data or an image or picture with sounds associated to it. Furthermore, the media data may comprise for example a telephone conference or a video conference or a video conference in which a plurality of person are speaking. By automatically determining voice characteristics of for example a person currently speaking in the media data, the contact information record of the person may be identified based on the determined voice characteristics. Therefore, the person currently speaking may be identified based on the identified contact information record.

According to an embodiment, the media data comprises a video data file and each contact information record comprises a person identifier which identifies the person. The person identifier may comprise for example a name or nick name of the person. According to the method, the person identifier of the determined at least one contact information record is assigned to meta data of the video data file. Therefore, an automatic tagging of the video data file may be accomplished.

According to another embodiment, the media data comprises an image data file comprising the audio voice data as associated data. In other words, the media data comprises for example a still image or picture to which audio data has been assigned or attached. For example, a digital camera may take a picture of a person while the person is speaking and the audio voice data uttered by the person may be identified by the above-described method to tag the image with the person identifier of the person shown in the picture.

According to another embodiment, the media data comprises a sound data file comprising the audio voice data. Each contact information record comprises a person identifier identifying the person. The person identifier of the determined at least one contact information record is assigned to meta data of the sound data file. The sound data file may comprise for example a speech of the person or a music file with a singing person. Therefore, an automatic identification of the person may be accomplished based on the audio voice data assigned to the person.

According to another embodiment, the media data comprises a plurality of audio data channels, for example a plurality of audio data channels of a video conference or a telephone conference. Each contact information record comprises a person identifier identifying the person to which the contact information record relates. According to the method, for each of the plurality of audio data channels the above-described method for assigning voice characteristics to the contact information record of the corresponding person is performed. Furthermore, to each of the plurality of audio data channels the corresponding person identifier of the at least one contact information record which has been determined for the corresponding audio data channel is assigned. Thus, for example, in a video conference or a telephone conference, each participating person can be easily and automatically identified.

According to another embodiment, each contact information record comprises a person identifier identifying the person. The person identifier comprises for example a name of the person. According to this embodiment, based on the received audio voice data it is automatically determined, if the person to be identified is currently speaking. As long as the identified person is speaking, the person identifier is output via a user interface. For example, a name of the person may be output on a display of the user interface. Therefore, especially in video conferences or telephone conferences with a lot of participants, an identification of the person who is currently speaking may be automatically supported.

According to another aspect of the present invention, a user equipment comprising an access device and a processing device is provided. The access device provides an access to a plurality of contact information records. Each contact information record is assigned to a person and comprises voice characteristics of the person. The processing device is configured to receive media data comprising audio voice data of a person to be identified. Based on the received audio voice data, voice characteristics of the person to be identified are determined and at least one contact information record of the plurality of contact information records is determined based on the determined voice characteristics. The contact information record belonging to the person to be identified is determined by searching within the plurality of contact information records for voice characteristics which match the voice characteristics of the person to be identified. The user equipment may be configured to perform the above-described methods and comprises therefore also the above-described advantages. Furthermore, the user equipment may comprise for example a desktop computer, a telephone, a notebook computer, a tablet computer, a mobile telephone, or a mobile media player.

Although specific features described in the above summary and the following detailed description are described in connection with specific embodiments and aspects of the present invention, it should be noted that the features of the embodiments and aspects may be combined with each other unless specifically noted otherwise.

### BRIEF DESCRIPTION OF DRAWINGS

The present invention will now be described in more detail with reference to the accompanying drawings.

FIG. 1 shows schematically a user equipment according to an embodiment of the present invention.

FIG. 2 shows schematically method steps of a method according to an embodiment of the present invention.

FIG. 3 shows method steps of a method according to another embodiment of the present invention.

### DESCRIPTION OF EMBODIMENTS

In the following, exemplary embodiments of the invention will be described in more detail. It is to the understood that the features of the various exemplary embodiments described herein may be combined with each other unless specifically noted otherwise. Same reference signs in the various drawings refer to similar or identical components. Any coupling between components or devices shown in the figures may be a direct or an indirect coupling unless specifically noted otherwise.

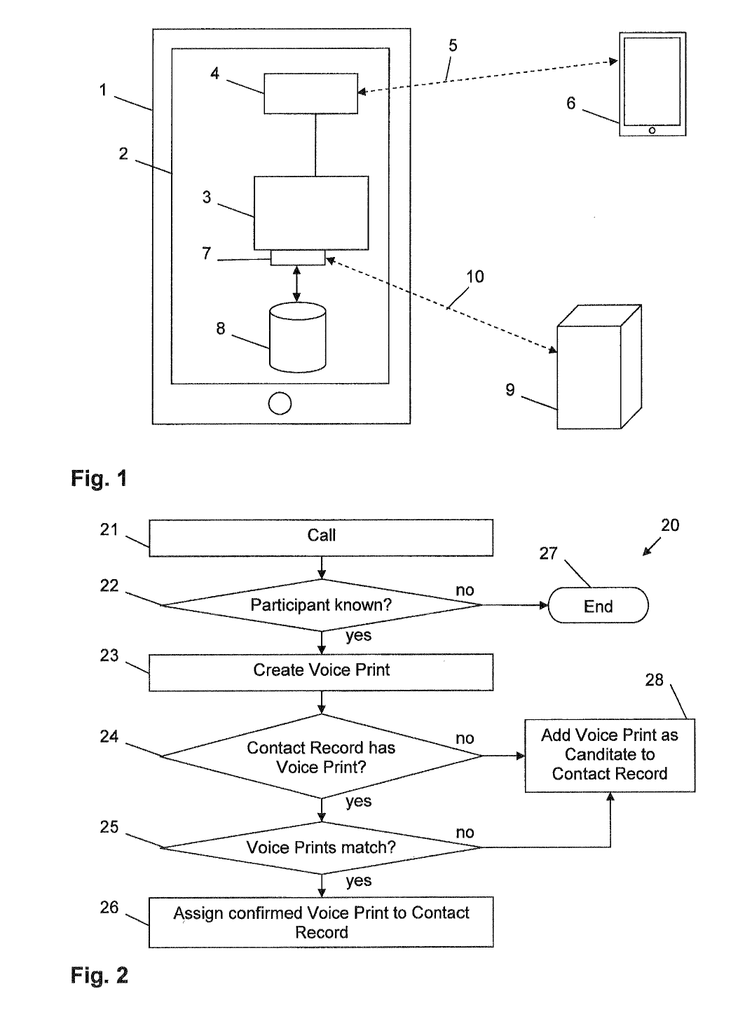

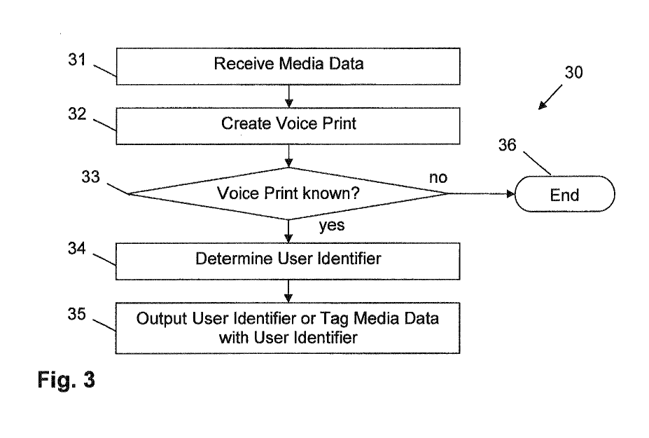

FIG. 1 shows schematically a user equipment 1. The user equipment 1 may comprise for example a mobile phone, especially a so called smart phone, or a tablet PC. However, the user equipment 1 may comprise any other communication device, for example a notebook computer or a desktop computer. The user equipment 1 comprises a display 2, for example a touch screen, and a processing device 3, for example a microprocessor. The user equipment 1 comprises furthermore a transceiver 4 for establishing a communication connection 5 to another user equipment 6. The communication connection 5 may comprise for example a voice communication or a video communication comprising a voice communication. The user equipment 1 comprises furthermore an access device 7 providing access to a plurality of contact information records. The plurality of contact information records may be stored for example in a database 8 of the user equipment 1 or in a server 9 to which the access device 7 sets up a communication connection 10. Each contact information record may comprise for example a person identifier, for example the name of a person and associated contact information, like for example a telephone number, a mobile telephone number, an e-mail address and so on. Each contact information record may comprise additional storage space for storing further information, for example voice characteristics, as will be described in more detail below. Voice characteristics, which may also be called a voice print, are an important biometric which may be used for identification just like a finger print. In the following, in connection with FIGS. 2 and 3 learning of voice prints and using of voice prints will be described in more detail.

FIG. 2 shows a method 20 comprising method steps 21-28 for learning voice prints and assigning them to contact information records. In step 21 a communication connection 5, for example a telephone call, is set up from the user equipment 1 to the other user equipment 6. In step 22 the processing device 3 checks if the participant of the communication connection 5 is known. For example, the processing device 3 may search for a contact information record which comprises the telephone number which has been used for setting up the communication connection 5 to the other user equipment 6. In case the participant is not known, the method 20 is terminated at step 27. Alternatively, however, it may be recommendable not to simply disregard an unknown voice print, but to store the voice print together with a corresponding identifier, such as a phone number, for a later use, so that the user has already the voice print assigned to the corresponding entry if the user should later decice to add this entry to the phone book. In conventional telephones, the phone number of an unknown caller is often stored in a call history list, so that the voice print of an unknown contact could be stored together with the phone number in the call history list, for example.

If the participant is known, audio voice data received via the communication connection 5 is captured by the processing device 3 and a voice print is automatically determined by the processing device 3 based on the captured audio voice data in step 23. If the contact information record relating to the participant of the call already has a voice print (step 24) the created voice print of the current communication connection 5 is compared with the already present voice print of the contact information record (step 25). If the voice prints are matching, the voice print is assigned as a confirmed voice print to the contact information record in step 26. Otherwise, the voice print is added as a “candidate” voice print to the contact information record in step 28. “candidate” voice print means that the voice print is not very reliable as it is based on a single sample only. As an alternative or in addition to the above described fully automatic matching process, it may also be possible that the user approves the voice print to have the voice print added to the contact information record.

To sum up, voice prints are learned or determined by recording voice prints when voice calls are performed. Voice calls may comprise any type of communication where the processing device 3 knows the participant, for example Skype calls, video calls and video conference calls. The determined voice prints are automatically stored in the appropriate contact, for example in a phone book. However, it is not guaranteed that the person designated in the contact information record is really talking at the other end of the communication connection 5. For example, a different person than the person to whom the other mobile device 6 belongs may be using the other mobile device 6. Therefore, the above-described method 20 does not use only one voice prints, but is uses two or even more voice prints relating to the same contact information record and checks if they match. If they match, the voice prints may be stored as a confirmed voice print for that person.

FIG. 3 shows a method 30 for using the voice prints determined according to the method 20 of FIG. 2. The method 30 comprises method steps 31-36. In step 31 media data is received by the processing device 3. The media data may comprise for example video data of a video stored in the user equipment 1 or captured with a camera and microphone of the user equipment 1, pictures with associated sounds stored in or captured by the user equipment 1, sound clips, or video or audio data of a telephone call or a telephone conference received by the transceiver 4 of the user equipment 1. In step 32 the processing device 3 analyses the received media data and determines from audio data of the received media data a voice print or voice characteristics. In step 33 the processing device 3 searches the contact information records of for example the data base 8 or the server 9 for a contact information record comprising a voice print which corresponds to the voice print created in step 32. If a matching voice print cannot be found, the method 30 is terminated in step 36. If a matching voice print has been found in step 33, a user identifier is determined in step 34 from the identified contact information record. The user identifier may comprise for example a name of the person relating to the contact information record. In step 35 the user identifier is for example output on a display of the user equipment 1 or is assigned to the media data, for example as tagging data of a video.

Thus, the voice prints determined according to the method 20 of FIG. 2, may be used for several applications. For example videos may be automatically tagged. By analyzing the sound in a video and matching this to the voice prints stored in the user equipment 1, it is possible to automatically tag people in the video. The same can be done for sound picture, i.e. pictures with sounds associated to them, and for sound clips. Furthermore, if the user equipment 1 comprises for example several microphones and a direction can be sensed, this may be used to tag people in virtual reality applications. Furthermore, people may be identified in a multiple-person chat or a video conference.

1. A method for assigning voice characteristics to a contact information record of a person in a user equipment, the method comprising:
automatically detecting, with a processing device of the user equipment, a communication connection of the user equipment relating to contact information of the contact information record of the person,
automatically capturing, with the processing device, audio voice data received via the communication connection,
automatically determining, with the processing device, the voice characteristics based on the captured audio voice data, and
automatically assigning, with the processing device, the determined voice characteristics to the contact information record of the person.

2. The method according to claim 1, wherein the method comprises:
automatically detecting, with the processing device, a further communication connection relating to contact information of the contact information record of the person,
automatically capturing, with the processing device, further audio voice data received via the further communication connection,
automatically determining, with the processing device, further voice characteristics based on the captured further audio voice data,
comparing, with the processing device, the voice characteristics and the further voice characteristics, and
automatically assigning, with the processing device, the determined voice characteristics as confirmed voice characteristics to the contact information record of the person based on the comparison.

3. The method according to claim 1, wherein the contact information record is stored in a database accessible by the processing device, wherein the voice characteristics are stored in the database.

4. The method according to claim 1, wherein determining the voice characteristics comprises analysing physiological biometric properties based on the audio voice data.

5. A user equipment comprising:
a transceiver for establishing a communication connection,
an access device for providing access to a plurality of contact information records, each contact information record comprising contact information and being assigned to a person, and
a processing device configured to
detect a communication connection of the transceiver,
identify a contact information record of the plurality of contact information records whose contact information matches the detected communication connection,
capture audio voice data received via the communication connection,
determine voice characteristics based on the captured audio voice data, and
assign the determined voice characteristics to the identified contact information record.

6. The user equipment according to claim 5, wherein the user equipment is configured to perform the method according to claim 1.

7. A method for automatically identifying a person with a user equipment, the method comprising:
providing a plurality of contact information records, each contact information record being assigned to a person and comprising voice characteristics of the person,
receiving, with a processing device of the user equipment, media data comprising audio voice data of the person to be identified,
automatically determining, with the processing device, voice characteristics of the person to be identified based on the received audio voice data, and
automatically determining, with the processing device, at least one contact information record of the plurality of contact information records whose voice characteristics matches the voice characteristics of the person to be identified.

8. The method according to claim 7, wherein the media data comprises a video data file, wherein each contact information record comprises a person identifier identifying the person, the method comprising:
assigning the person identifier of the determined at least one contact information record to metadata of the video data file.

9. The method according to claim 7, wherein the media data comprises an image data file comprising the audio voice data as associated data, wherein each contact information record comprises a person identifier identifying the person, the method comprising:
assigning the person identifier of the determined at least one contact information record to metadata of the image data file.

10. The method according to claim 7, wherein the media data comprises a sound data file comprising the audio voice data, wherein each contact information record comprises a person identifier identifying the person, the method comprising:
assigning the person identifier of the determined at least one contact information record to metadata of the sound data file.

11. The method according to claim 7, wherein the media data comprises a plurality of audio data channels, wherein each contact information record comprises a person identifier identifying the person, the method further comprising:
performing the method of claim 1 for each of the plurality of audio data channels, and
assigning to each of the plurality of audio data channels the corresponding person identifier of the at least one contact information record determined for the corresponding audio data channel.

12. The method according to claim 7, wherein each contact information record comprises a person identifier identifying the person, the method comprising:
determining if the person to be identified is currently speaking based on the received audio voice data, and
outputting the person identifier via a user interface as long as the identified person is speaking.

13-15. (canceled)

16. The method according to claim 7, wherein each contact information record comprises a person identifier identifying the person, the method further comprising:
receiving the audio voice data by several microphones of the user equipment and sensing a direction, and
tagging the identified person in a virtual reality application with the person identifier based on the received audio voice data and the sensed direction.

17. The method according to claim 7, wherein the media data comprises a multi- person chat or a video, conference, the method further comprising:
identifying the persons in the multi-person chat or the video conference.

18. A user equipment comprising:
an access device for providing access to a plurality of contact information records, each contact information record being assigned to a person and comprising voice characteristics of the person, and
a processing device configured to
receive media data comprising audio voice data of a person to be identified,
determine voice characteristics of the person to be identified based on the received audio voice data, and
determine at least one contact information record of the plurality of contact information records whose voice characteristics matches the voice characteristics of the person to be identified.

19. The user equipment according to claim 18, wherein the user equipment is configured to perform the method according to claim 7.

20. The user equipment according to claim 18, wherein the user equipment comprises a device comprising at least one of a group comprising a desktop computer, a telephone, notebook computer, a tablet computer, a mobile telephone, and a mobile media player.

21. The user equipment according to claim 18, wherein each contact information record comprises a person identifier identifying the person, the user equipment comprising:
several microphones for receiving the audio voice data and sensing a direction, wherein the user equipment is configured to tag the identified person in a virtual reality application with the person identifier based on the received audio voice data and the sensed direction.

22. The user equipment according to claim 18, wherein the media data comprises a multi-person chat or a video conference, wherein the user equipment is configured to identify the persons in the multi-person chat or the video conference.
